(19) United States
(12) Patent Application Publication
(10) Pub. No.: US 2025/0360885 A1
(43) Pub. Date: Nov. 27, 2025

(54) CUSTOMIZABLE HARNESS INTERFACE CONNECTOR

(71) Applicant: International Truck Intellectual Property Company, LLC, Lisle, IL (US)

(72) Inventors: Suhaib Mohammad Shahab, Lisle, IL (US); Wesley Aaron Whipple, Lisle, IL (US); Constantin S. Busuioc, Plainfield, IL (US); Jay E. Bissontz, Spencerville, IN (US); Angel Luis Ramos, Floresville, TX (US)

(73) Assignee: International Truck Intellectual Property Company, LLC, Lisle, IL (US)

(21) Appl. No.: 19/085,099

(22) Filed: Mar. 20, 2025

Related U.S. Application Data
(60) Provisional application No. 63/651,459, filed on May 24, 2024.

(51) Int. Cl. B60R 16/02; H01R 13/10

(52) U.S. Cl. CPC B60R 16/0207; H01R 13/10; H01R 2201/26

(57) ABSTRACT

A customizable harness interface connector is disclosed. The customizable harness interface connector includes a harness housing; a plurality of connector receptacles; and one or more milled channels disposed within the plurality of connector receptacles and extending downward into the harness housing, where the one or more milled channels are configured to receive one or more electrical/electronic component to feed into the harness housing. The customizable interface connector accommodates specific components by allowing axial semiconductors, dual in-line packaged components, and the like to be placed within a connector like fixture and act as a breadboard by securing the leads and allowing wires to be passed through on both sides of the connector, creating a compact and robust circuit that can be placed anywhere within a vehicle.

### CROSS REFERENCE TO RELATED APPLICATIONS

This patent application claims priority from U.S. provisional patent application Ser. No. 63/651,459 filed on May 24, 2024, and is incorporated herein in its entirety by this reference.

### FIELD OF THE INVENTION

The present disclosure relates generally to a connector for vehicle electrical harnesses, and more particularly, and without limitation, to such a vehicle electrical harness having a customizable interface connector.

### BACKGROUND

Designing a new electrical solution on a vehicle is a difficult and lengthy process due to needing to match the form factor of all the components. By making a connector design which allows for the modification of circuits with at least one off the shelf conductor, semiconductor, and/or smart device, it will be easier to modify and manufacture components on a case-by-case basis, significantly decreasing the cost of a specialized component or potted device. This device also allows testing to be streamlined due to the customizability of the internal components.

### SUMMARY OF THE INVENTION

In an aspect of the disclosure, a customizable harness interface connector is disclosed. The customizable harness interface connector includes a harness housing; a plurality of connector receptacles; and one or more milled channels disposed within the plurality of connector receptacles and extending downward into the harness housing, where the one or more milled channels are configured to receive one or more electrical/electronic component to feed into the harness housing.

In an aspect of the present disclosure, a customizable harness interface connector is disclosed. The customizable harness interface connector includes a harness housing; a plurality of connector receptacles inside the harness housing; and one or more milled channels disposed within the plurality of connector receptacles and extending downward into the harness housing, wherein the one or more milled channels are configured to receive one or more electrical components therein to feed into the harness housing.

In some embodiments of this aspect, the one or more milled channels are disposed within the plurality of connector receptacles on one side of the customizable harness interface connector. In some embodiments of this aspect, the one or more milled channels are disposed within the plurality of connector receptacles on both sides of the customizable harness interface connector. In some embodiments of this aspect, the one or more milled channels are configured to receive the one or more electrical components which are not sized for use with a conventional harness interface connector. In some embodiments of this aspect, the one or more electrical components comprises at least one of a passive discrete electronic component and an active discrete electronic component.

In some embodiments of this aspect, the one or more electrical components comprises an axial semiconductor device including leads connecting the axial semiconductor device to the harness housing via the one or more milled channels. In some embodiments of this aspect, the leads of the axial semiconductor device are further connected to lead wires inserted into the plurality of connector receptacles. In some embodiments of this aspect, the one or more electrical components comprises a dual in-line packaged (DIP) device. In some embodiments of this aspect, the customizable harness interface connector is connected to an external electronic component.

In another aspect of the present disclosure, a customizable harness interface connector for a harness is provided. The customizable harness interface connector includes a harness housing; a plurality of connector receptacles inside the harness housing; and a breadboard interface configured to receive one or more electrical components on a first side of the customizable harness interface connector, and a second side of the customizable harness interface connector is configured to receive one or more signals from a packaged device to distribute to a rest of the harness.

In some embodiments of this aspect, the breadboard interface includes a dual inline packaging (DIP) connector array. In some embodiments of this aspect, the breadboard interface includes a plurality of receptacles for insertion of at least one wire or lead of the one or more electrical components. In some embodiments of this aspect, the customizable harness interface connector further includes a central processing unit (CPU) and a logic gate inserted into the breadboard interface. In some embodiments of this aspect, the customizable harness interface connector further includes one or more milled channels disposed within the plurality of connector receptacles and extending downward into the harness housing, wherein the one or more milled channels are configured to receive one or more electrical components therein to feed into the harness housing.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope.

FIG. 1A illustrates a plan view of a conventional harness interface connector;

FIG. 1B illustrates a plan view of a disclosed customizable harness interface connector, according to aspects of the disclosure;

FIG. 1C illustrates another plan view of a disclosed customizable harness interface connector, according to aspects of the disclosure;

FIG. 2A illustrates a cross-sectional view of the conventional harness interface connector;

FIG. 2B illustrates a cross-section view of a disclosed customizable harness interface connector from FIG. 1B, according to aspects of the disclosure;

FIG. 2C illustrates a cross-section view of a disclosed customizable harness interface connector from FIG. 1C, according to aspects of the disclosure;

FIG. 3 is a plan view of an example customizable harness interface connector, according to one embodiment of the disclosure;

FIG. 4A is a perspective top view of a conventional harness interface connector;

FIG. 4B is a perspective view of an example customizable harness interface connector, according to one embodiment of the disclosure;

FIG. 5A is a plan view of an example customizable harness interface connector in an assembled configuration according to an aspect of the disclosure;

FIG. 5B illustrates an example electrical/electronic component that may be used with the example customizable harness interface connector of FIG. 5A, according to an aspect of the disclosure; and

FIG. 6 is a perspective top view of an example customizable harness interface connector in an assembled configuration, in use providing electrical connection to an electronic component, according to an aspect of the disclosure.

In the following detailed description, various embodiments are described with reference to the appended drawings. The skilled person will understand that the accompanying drawings are schematic and simplified for clarity. Like reference numerals refer to like elements or components throughout. Like elements or components will therefore not necessarily be described in detail with respect to each figure.

### DETAILED DESCRIPTION

Potting semiconductors or smart devices on a connector body is typically only done one component at a time and with standard values. This is problematic because it lacks the variability and customizability needed within more sensitive circuits that require specific voltages or resistance values.

According to an aspect of the disclosure, a customizable harness interface connector may solve the issue of needing specific components by allowing axial semiconductors, dual in-line packaged components, and the like to be placed within a connector like fixture and act as a breadboard by securing the leads and allowing wires to be passed through on both sides of the connector, creating a compact and robust circuit that can be placed anywhere within a vehicle. This disclosed customizable harness interface connector may also allow the use of nonstandard valued components, making the use of highly specialized devices more accessible.

In an aspect of the disclosure, the disclosed customizable harness interface connector may allow a decrease in the time between design and manufacturing of components requiring specific and/or unusual components in an axial semiconductor, dual in-line packaged device, and the like. In an aspect, the disclosed customizable harness interface connector may allow circuits to be modified to support chassis integration and body builder equipment when necessary and applicable. The disclosed customizable harness interface connector may also allow circuits to be modified in the instance of components within it being damaged without further repair of the harness to which is connected.

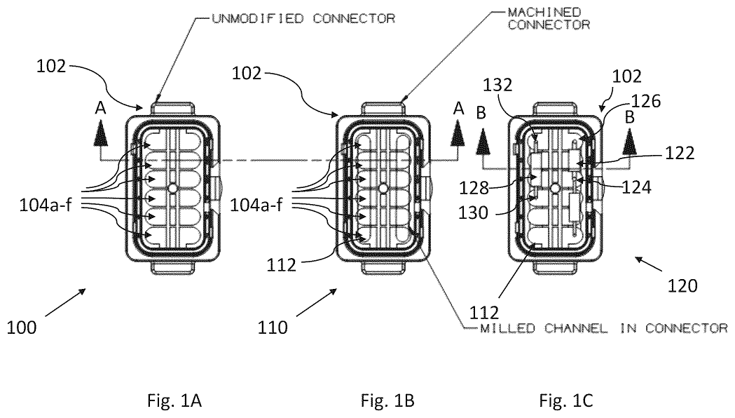

Referring to FIG. 1A, a conventional harness interface connector 100 is illustrated. The conventional electrical connector harness 100 includes a harness housing 102. The conventional harness interface connector 100 includes a plurality of connector receptacles 104a-f. The plurality of connector receptacles 104a-f have corresponding connector receptacles on the other side of the conventional harness interface connector 100 as shown in FIG. 1a. The number of connector receptacles in the conventional harness interface connector 100 may vary as needed for an application and may not be limited to the 6 shown in FIG. 1A. More or fewer connector receptacles may be present on the conventional harness interface connector 100. The plurality of connector receptacles 104a-f may be adapted to receive lead wires, for example, to connect lead wires from an external electrical/electronic component to the conventional harness interface connector 100. The lead wires may transfer information or power over the electrical harness coupled with the conventional harness interface connector 100, such as a wire harness in a vehicle.

FIG. 1B illustrates a disclosed customizable harness interface connector 110. The customizable harness interface connector 110 may include a harness housing 102, similar to the harness housing 110 shown in FIG. 1A. The customizable harness interface connector 110 may include a plurality of connector receptacles 104a-f, similar to the connector receptacles 104a-f shown in FIG. 1A. The customizable harness interface connector 110 may include one or more milled channels 112 are created within the plurality of connector receptacles 104a-f on one or both sides of the customizable harness interface connector 110 and extend downward into the housing harness 102. The milled channels 112 may be adapted and configured to receive various electrical and electronic components that would not be used with the plurality of connector receptacles 104a-f of a conventional harness interface connector 100 because of sizing or positioning of the plurality of connector receptacles 104a-f of a conventional harness interface connector 100. Examples of electrical/electronic components that may be used with the customizable harness interface connector 110 include, but are not limited to, passive and active discrete electronic components such as resistors, capacitors, inductors, sensors, potentiometers, op-amps, amplifiers, transistors, axial semiconductors, dual in-line packaged device, and the like, or other electrical/electronic components with leads that may be inserted into the one or more milled channels 112.

FIG. 1C illustrates a customizable harness interface connector 120 with one or more electrical/electronic components inserted into the one or more milled channels 112 within a plurality of connector receptacles 104a-f (corresponding to the plurality of connector receptacles 104a-f illustrated in FIG. 1B). In FIG. 1C, three electrical/electronic components are illustrated, including an axial semiconductor device 124 and 128. The axial semiconductor device 122 and 128 may include leads 124 and 126, and 130 and 132, connecting the axial semiconductor device 124 and 128 to the harness housing 102 via the one or more milled channels 112 within a plurality of connector receptacles 104a-f. More or fewer than the number of axial semiconductor device 122 and 128 illustrated may be present. Other electrical/electronic components may also be used as customized for the application of the electrical harness.

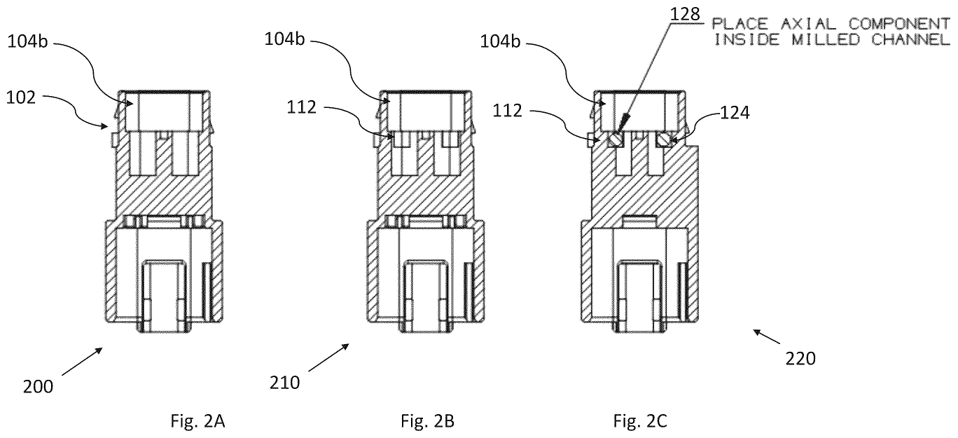

FIGS. 2A, 2B and 2C illustrate, respectively, cross-sections of the conventional harness interface connector 200, the customizable harness interface connector 210 and customizable harness interface connector 220. FIG. 2A corresponds to a cross-section of the conventional harness interface connector 100 along cut-line A-A in FIG. 1A. A connector receptacle 104b of the plurality of connector receptacles 104a-f is shown as an example in cross-section.

Referring to FIG. 2B, the customizable harness interface connector 210 is shown in cross-section arising from cut-line A-A, similar to that of FIG. 2A. The customizable harness interface connector 210 includes a connector receptacle 104b of the plurality of connector receptacles 104a-f. The customizable harness interface connector 210 includes a milled channel 112 of the one or more milled channels 112 shown in FIG. 1B. As described above, the one or more milled channels 112 may be adapted and configured to receive various electrical and electronic components that would not be used with the plurality of connector receptacles 104a-f of a conventional harness interface connector 200 because of sizing or positioning of the plurality of connector receptacles 104a-f of a conventional harness interface connector 200.

In an aspect, other examples of electrical/electronic components that may be used with the customizable harness interface connector 220 include, but are not limited to, passive and active discrete electronic components such as resistors, capacitors, inductors, sensors, potentiometers, op-amps, amplifiers, transistors, axial semiconductors, dual in-line packaged device, and the like, or other electrical/electronic components with leads that may be inserted into the one or more milled channels 112.

Referring to FIG. 2C, the customizable harness interface connector 220 is shown in cross-section arising from cut-line B-B from FIG. 1C. Illustrated in FIG. 2C are portions of leads 124 and 126, and 130 and 132, connecting the axial semiconductor device 124 and 128 to the harness housing 102 via the one or more milled channels 112 within a plurality of connector receptacles 104a-f.

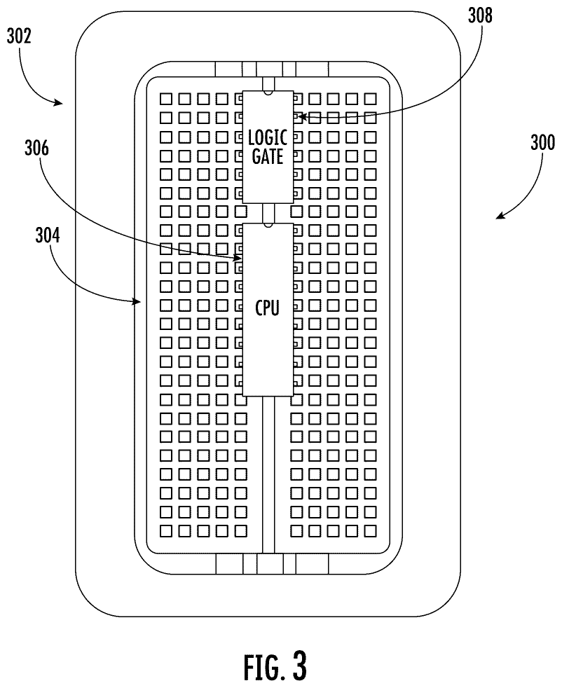

FIG. 3 illustrates a different aspect of the disclosure as a customizable harness interface connector 300. The customizable harness interface connector 300 may include a connector harness 302, which may be similar to the connector harnesses 102 in FIGS. 1A-1C. The customizable harness interface connector 300 may include a breadboard interface 304, such as a dual inline packaging (DIP) connector array as one example breadboard interface 304. The breadboard interface 304 may include a large number of receptacles for insertion of wires or leads of electrical/electronic components. In an aspect, the customizable harness interface connector 300 may include a CPU 306 and a logic gate 308 inserted into the breadboard interface 304. Other examples of DIP or axial semiconductor components may be used as required by an application requiring a wire harness and harness interface connector.

In some embodiments, by using a breadboard interface that uses bus bars and has open pin outs on both faces, one can pass wires that connect with each other on either side of the connector and that interface with the DIP components shown in FIG. 3

In an aspect of the disclosure, the breadboard interface 304 is configured to receive one or more electrical/electronic components on a first side of the customizable harness interface connector 300 (the breadboard interface 304), and where a second side of the customizable harness interface connector 300 (opposite the first side, not shown) is configured to receive one or more signals from a packaged device to distribute to the rest of the harness.

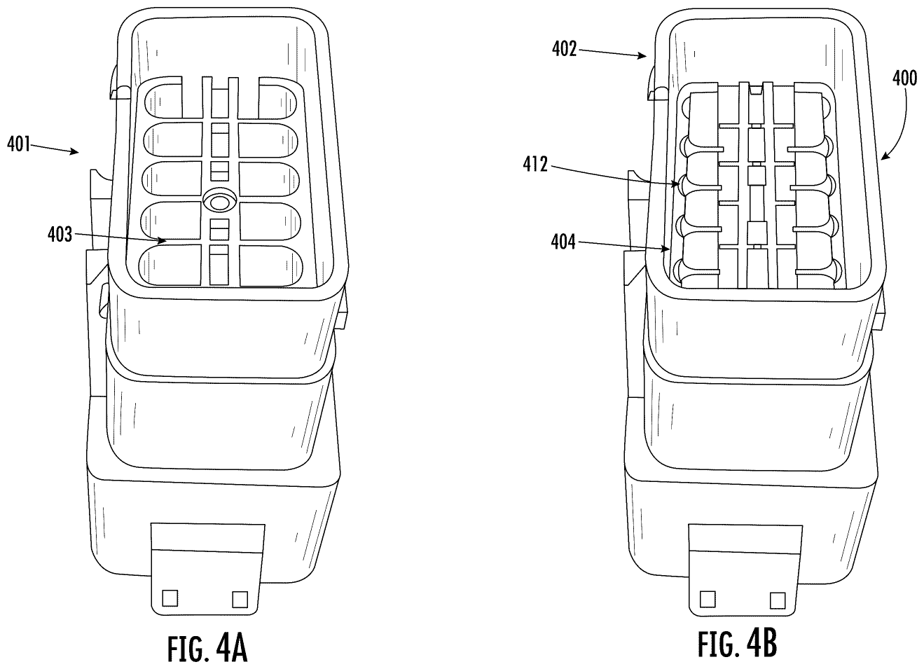

FIG. 4A and FIG. 4B illustrate another aspect of the disclosure, customizable harness interface connector 400 and conventional harness interface connector 401, in relief views. The customizable harness interface connector 400 may include a plurality of connector receptacles 404 and one or more milled channels 412, similar to the plurality of connector receptacles 104a-f and the one or more milled channels 112 as illustrated in FIG. 1B. The conventional harness interface connector 401 includes conventional connector receptacles without any milled channels as illustrated in FIG. 1A. As can be seen in a side-by-side visual comparison, whereas the conventional harness interface connector 401 includes flat, planar ledges 403, the one or more milled channels 412 in the customizable harness interface connector 400 provide one or more recesses or grooves shaped and configured to receive, support, protect and secure one or more electrical/electronic components therein. The one or more milled channels 112 is shown in FIG. 4B as a U-shaped recess/groove. In alternative embodiments, the one or more milled channels may be provided in other shapes, such as, L-shaped, T-shaped, C-shaped, V-shaped, slanted, curved, and the like.

In some embodiments, at least one of the one or more channels may be shaped differently from at least one of the other channels to accommodate of different types of electrical/electronic components that have different dimensions. In some embodiments, the one or more channels may include a first set of channels provided in a first shape and a second set of channels provided in a second shape, with the first shape being different from the second shape. In some embodiments, the one or more channels are limited in size by at least the dimensions of the sidewalls of the connector receptacles, and particularly the length of the top ledge of such sidewalls. In some embodiments, the one or more channels are defined by recessed portions of the top ledge of the receptacle sidewalls. In some embodiments, the one or more channels may be dimensioned to receive a portion of an electrical/electronic component therein.

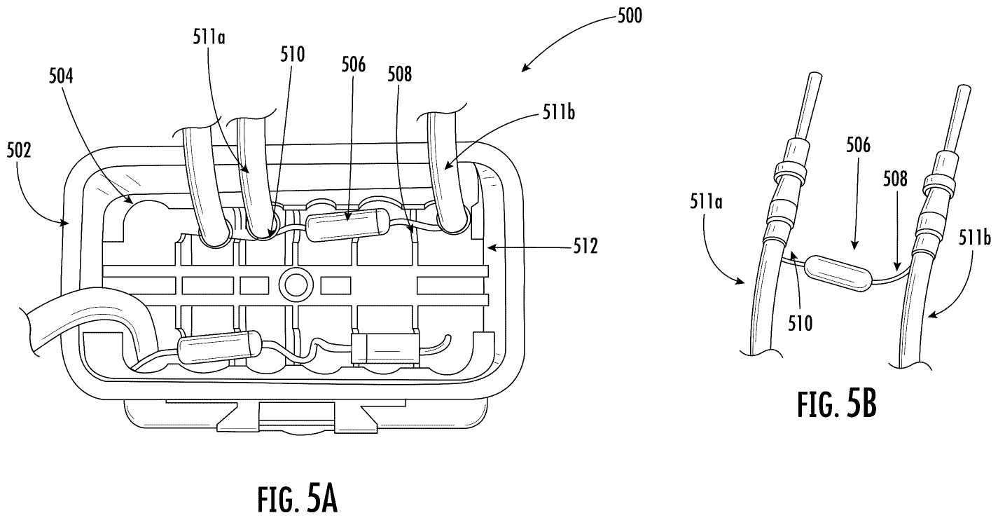

FIG. 5A illustrates another aspect of the disclosure, customizable harness interface connector 500, in a plan view. The customizable harness interface connector 500 may include a connector harness 502, a plurality of connector receptacles 504 and one or more milled channels 512. The customizable harness interface connector 500 may be configured to receive an electrical/electronic component 506, such as an axial semiconductor component. Other examples of electrical/electronic components may be used as described herein, including customized size or values associated with the component, depending on a user's application. The electrical/electronic component 506 may have leads 508 and 510 for insertion into one or more of the plurality of connector receptacles 504 within the one or more milled channels 512. Wire leads 511a, 511b may also be inserted into one or more of the plurality of connector receptacles 504 within the one or more milled channels 512.

FIG. 5B shows a close-up view of the electrical/electronic component 506. The electrical/electronic component 506 may include leads 508, 510, which may be connected to lead wires 511a, 511b when inserted into one or more of the plurality of connector receptacles 504 within the one or more milled channels 512.

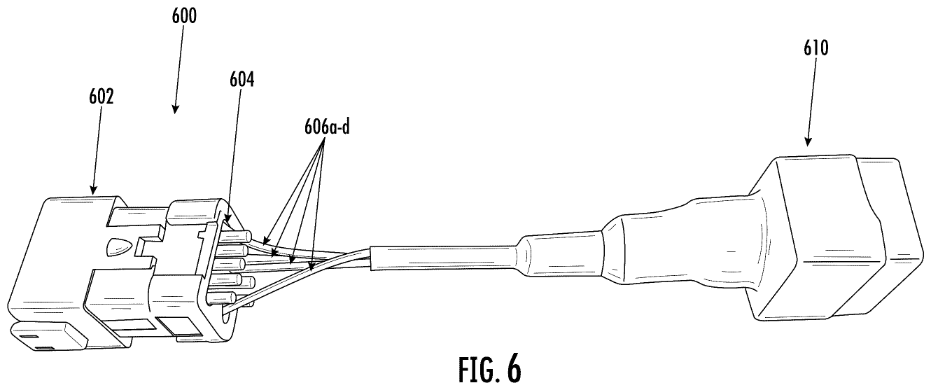

FIG. 6 illustrates a further aspect of the disclosure, where a customizable harness interface connector 600 may be connected to an electronic component 610 in an application of the customizable harness interface connector 600. The customizable harness interface connector 600 may include a connector housing 602 (similar to connector housing 102 in FIGS. 1B and 1C) and a plurality of connector receptacles 604 (similar to the plurality of connector receptacles 404 in FIG. 4B). Not shown is one or more milled channels described in connection with FIGS. 1B, 1C, 2B and 2C, for example. In FIG. 6, four wires 606a-d are connected to the customizable harness interface connector 600. The wires 606a-d are in electrical communication with the electronic component 610.

As used herein, the term “connecting” refers to the act of joining, linking, or fastening two or more objects together to enable structural, mechanical, or electrical continuity. This may involve direct contact, interlocking parts, or the use of fasteners, adhesives, or conductive materials to create a secure or functional union between the connected objects. Electrical connectivity may include use of wires, terminals, crimping or the like.

As used herein, the phrase “milled channels” refers to material (e.g., material that the plurality of receptacles are made of) that is shaped, cut or formed to achieve a desired geometry using mechanical, thermal, chemical, additive techniques, or the like.

A used herein, the phrase “feed into” may refer to physically inserting or guiding a component into the harness housing (e.g., a wire, terminal, or module is fed into a connector for proper placement) and/or electrically connecting or transmitting signals/power into the harness housing, allowing communication or power to flow therethrough.

As used herein, the term “breadboard” is used broadly to refer to a device configured for testing, using or designing electronic circuits without the need for soldering (e.g., a plastic board with a matrix of holes into which electrical components can be inserted and connected to metal strips beneath the surface). In some embodiments, the breadboard is a structural surface element predisposed for the integration of secondary modular sub-component/s, also being predisposed with at least one perforation extending from one surface of the structural element to a second surface. This could imply one or more series of holes or passages that could extend from one surface of a three-dimensional form to another surface of the same three-dimensional form for the mounting of components (e.g., semiconductors, micro relays, conductors/wires, and the like).

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity. Unless otherwise noted, the use of the words “approximate,” “about,” “around,” “substantially,” etc., mean plus or minus ten percent.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

I/We claim:

1. A customizable harness interface connector comprising:
a harness housing;
a plurality of connector receptacles inside the harness housing; and
one or more milled channels disposed within the plurality of connector receptacles and extending downward into the harness housing, wherein the one or more milled channels are configured to receive one or more electrical components therein to feed into the harness housing.

2. The customizable harness interface connector of claim 1, wherein the one or more milled channels are disposed within the plurality of connector receptacles on one side of the customizable harness interface connector.

3. The customizable harness interface connector of claim 1, wherein the one or more milled channels are disposed within the plurality of connector receptacles on both sides of the customizable harness interface connector.

4. The customizable harness interface connector of claim 1, wherein the one or more milled channels are configured to receive the one or more electrical components which are not sized for use with a conventional harness interface connector.

5. The customizable harness interface connector of claim 4, wherein the one or more electrical components comprises at least one of a passive discrete electronic component and an active discrete electronic component.

6. The customizable harness interface connector of claim 4, wherein the one or more electrical components comprises an axial semiconductor device including leads connecting the axial semiconductor device to the harness housing via the one or more milled channels.

7. The customizable harness interface connector of claim 6, wherein the leads of the axial semiconductor device are further connected to lead wires inserted into the plurality of connector receptacles.

8. The customizable harness interface connector of claim 4, wherein the one or more electrical components comprises a dual in-line packaged (DIP) device.

9. The customizable harness interface connector of claim 1, wherein the customizable harness interface connector is connected to an external electronic component.

10. A customizable harness interface connector for a harness comprising:
a harness housing;
a plurality of connector receptacles inside the harness housing; and
a breadboard interface configured to receive one or more electrical components on a first side of the customizable harness interface connector, and wherein a second side of the customizable harness interface connector is configured to receive one or more signals from a packaged device to distribute to a rest of the harness.

11. The customizable harness interface connector of claim 10, wherein the breadboard interface includes a dual inline packaging (DIP) connector array.

12. The customizable harness interface connector of claim 10, wherein the breadboard interface includes a plurality of receptacles for insertion of at least one wire or lead of the one or more electrical components.

13. The customizable harness interface connector of claim 10, further comprising:
a central processing unit (CPU) and a logic gate inserted into the breadboard interface.

14. The customizable harness interface connector of claim 10, further comprising:
one or more milled channels disposed within the plurality of connector receptacles and extending downward into the harness housing, wherein the one or more milled channels are configured to receive one or more electrical components therein to feed into the harness housing.
